(19) United States
(12) Patent Application Publication
(10) Pub. No.: US 2021/0184593 A1
(43) Pub. Date: Jun. 17, 2021

(54) Inverter System and Method for Operating an Inverter System

(71) Applicant: Vestel Elektronik Sanayi ve Ticaret A.S., Manisa (TR)

(72) Inventors: Ercan ER, Manisa (TR); Mert Serdar BÍLGÍN, Manisa (TR)

(21) Appl. No.: 17/262,671

(22) PCT Filed: Jul. 25, 2018
(86) PCT No.: PCT/EP2018/070163

§ 371 Date: Jan. 22, 2021

(51) Int. Cl. H02M 7/48; H02J 3/01; H02J 3/38; H02M 1/12

(52) U.S. Cl. CPC H02M 7/48; H02J 3/01; H02J 2300/24; H02M 1/12; H02M 2007/4822; H02J 3/381

(57) ABSTRACT

Inverter system, e.g. for a solar power system, has a plurality of inverters each having an input connectable to at least one DC source, an inverter circuit for converting a DC current into an AC current, and an output connected to a bus which is connectable to a grid. The inverter system further has a controller for controlling said plurality of inverters which is configured to control the switching processes of said inverter circuits of said plurality of inverters such that the switching processes of at least two inverters of said plurality of inverters are phase-shifted relative to each other.

### CROSS REFERENCE TO RELATED APPLICATION

This application is a US 371 application from PCT/EP2018/070163 entitled “Inverter System and Method for Operating an Inverter System” filed on Jul. 25, 2018 and published as WO 2020/020452 A1 on Jan. 30, 2020. The technical disclosures of every application and publication listed in this paragraph are hereby incorporated herein by reference.

### TECHNICAL FIELD

The present disclosure relates to an inverter system comprising a plurality of inverters, a solar power system comprising such an inverter system, and a method for operating an inverter system comprising a plurality of inverters.

### BACKGROUND

Solar power systems are of growing importance. Solar power systems are used for example to generate electric power or heat by using a large number of solar panels. In general, a solar power system comprises an inverter system having a plurality of inverters to transform the DC power generated by the solar panels into controlled AC power using e.g. pulse width modulation (PWM) switching. Because of the switching, the AC current supplied from the inverters to a grid has switching ripples which cause a distortion on the grid. This total harmonic distortion (THD) is limited by standards. Accordingly, there is a need for reducing THD.

For reducing THD, conventional inverter systems use filters with passive circuit elements at the output for filtering the switching ripples. For better filtering of the switching ripples, the passive circuit elements such as inductances (L) and capacitances (C) have to be large. This means that the passive circuit elements need more space and are more expensive.

### SUMMARY

According to a first aspect disclosed herein, there is provided an inverter system, comprising a plurality of inverters each having an input connectable to at least one DC source, an inverter circuit for converting a DC current into an AC current, and an output connected to a bus which is connectable to a grid, and a controller for controlling the plurality of inverters which is configured to control the switching processes of the inverter circuits of the plurality of inverters such that the switching processes of at least two inverters of the plurality of inverters are phase-shifted to each other.

In an example, the switching processes of all inverters or all active converters are phase-shifted to each other. The inverters of the inverter system may be single-phase or multiple-phase inverters. The grid may be a public grid or an isolated grid.

By adding a phase angle to the switching processes of the inverter circuits of the inverters, the current ripples of the AC currents generated by the inverters also have a phase angle. As a result, the summation of the AC currents generated by the inverters at the bus will eliminate or at least reduce the current ripples mutually so that the AC current provided by the inverter system has an improved THD level. The inverter system does not need special filtering having additional circuit elements so that it has a simple and cheap configuration.

In an example of the first aspect, one inverter of the plurality of inverters serves as the controller. In other words, the inverter system includes a master-slave system with one inverter being the master-inverter and the other inverters being the slave-inverters, wherein the switching processes of the slave-inverters are controlled by the master-inverter. Alternatively, the inverter system may have a separate master controller for controlling all inverters of the plurality of inverters.

In an example of the first aspect, the plurality of the inverters and the controller are connected to each other via a communication line. In an example, each of the inverters comprises a controller, and the controllers of the plurality of inverters are connected to each other via the communication line.

In another example of the first aspect, the switching processes of the plurality of inverters are each controlled by a respective carrier wave signal having a modulation frequency to generate a PWM output signal, and the controller is configured to phase-shift the carrier wave signals of at least two inverters, in an example all or all active inverters of said plurality of inverters, relative to each other. The carrier wave signal may have for example a triangular or saw tooth waveform.

In yet another example of the first aspect, a phase difference between the phase-shifted switching processes of two inverters of the plurality of inverters is δ=360°/m with m being the total number of inverters or active inverters.

According to a second aspect disclosed herein, a solar power system comprises an above-described inverter system according to any of the first aspect and examples of the first aspect, and a plurality of solar energy devices connected to the inputs of the plurality of inverters of the inverter system.

According to a third aspect disclosed herein, in a method for operating an inverter system comprising a plurality of inverters each having an input connectable to at least one DC source, an inverter circuit for converting a DC current into an AC current, and an output connected to a bus which is connectable to a grid, the switching processes of the inverter circuits of the plurality of inverters are controlled such that the switching processes of at least two inverters of the plurality of inverters are phase-shifted relative to each other.

In an example, the switching processes of all inverters or all active converters are phase-shifted to each other. The inverters of the inverter system may be single-phase or multiple-phase inverters. By adding a phase angle to the switching processes of the inverter circuits of the inverters, the current ripples of the AC currents generated by the inverters also have a phase angle. As a result, the summation of the AC currents generated by the inverters at the bus will eliminate or at least reduce the current ripples mutually so that the AC current provided by the inverter system has an improved THD level. The inverter system does not need special filtering having additional circuit elements so that it has a simple and inexpensive configuration.

In an example of the third aspect, the switching processes of the inverter circuits of the plurality of inverters are controlled by one inverter of the plurality of inverters, which acts as a master-inverter. This means the inverter system includes a master-slave system with one inverter being the master-inverter and the other inverters being the slave-inverters, wherein the switching processes of the slave-inverters are controlled by the master-inverter. Alternatively, all inverters of the plurality of inverters may be controlled by a separate master controller.

In an example of the third aspect, the switching processes of the plurality of inverters are each controlled by a carrier wave signal having a modulation frequency to generate a PWM output signal, wherein the carrier wave signals of at least two of the plurality of inverters, in an example all or all active inverters of the plurality of inverters, are phase-shifted relative to each other. The carrier wave signal may have for example a triangular or saw tooth waveform.

In another example of the third aspect, a phase difference between the phase-shifted switching processes of two inverters of the plurality of inverters is δ=360°/m with m being the total number of inverters or active inverters.

### BRIEF DESCRIPTION OF THE DRAWINGS

To assist understanding of the present disclosure and to show how embodiments may be put into effect, reference is made by way of example to the accompanying drawings in which:

FIG. 1 shows schematically the configuration of an example of an inverter system according to an embodiment of the present disclosure;

FIG. 2 shows schematically diagrams for explaining the PWM structure of the inverter circuits of the inverters according to an example of the present disclosure;

FIG. 3 shows schematically diagrams for explaining the switching ripples of one inverter of the inverter system according to an example of the present disclosure;

FIG. 4 shows schematically a diagram for explaining the phase-shifted carrier wave signals according to an example of the present disclosure;

FIG. 5 shows schematically diagrams for comparing the output currents of an inverter system according to an example of the present disclosure and a conventional inverter system; and

FIG. 6 shows schematically zoomed details of the diagrams of FIG. 7.

### DETAILED DESCRIPTION

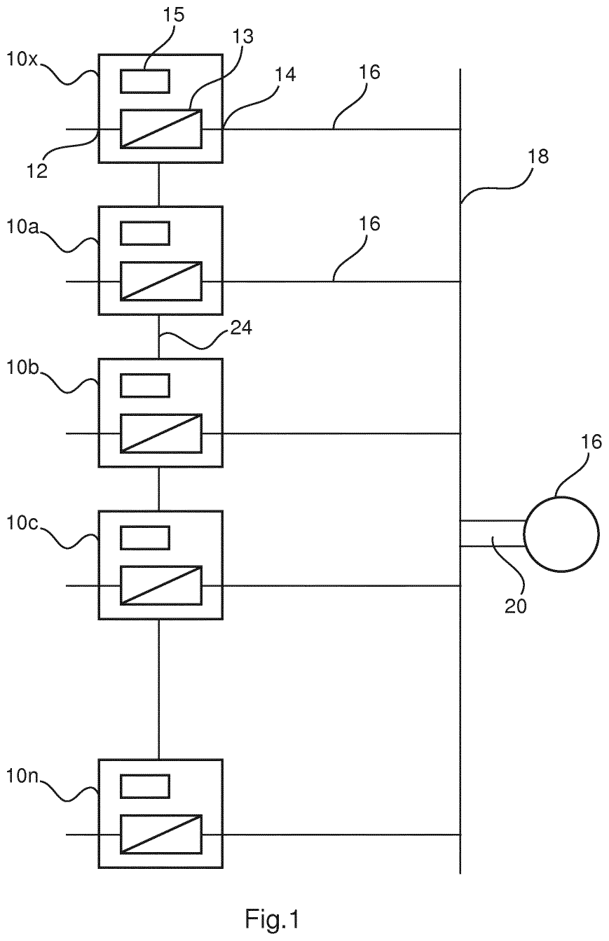

FIG. 1 shows schematically an embodiment of an inverter system for a solar power system according to an example of the present disclosure.

The inverter system comprises a plurality of inverters 10x and 10a . . . n, wherein one inverter 10x serves as a master-inverter and the other inverters 10a . . . n serve as slave-inverters.

Each of the inverters 10x, 10a . . . n comprises an input 12 which can be connected to a at least one solar energy device serving as a DC source. The solar energy devices convert incident solar energy into electrical energy. The solar energy devices may be in the form of for example a solar panel, which has a number of solar cells, which generate electrical power from incident solar energy. A solar cell is an electrical device that converts the energy of light into electricity. A solar cell may be for example a photovoltaic device which is a semiconductor device that converts light energy directly into electricity by the photovoltaic effect. As an alternative, the solar energy devices may be in the form of “concentrators”, which concentrate the solar energy into a small area.

Further, each inverter 10x, 10a . . . n comprises an inverter circuit 13 for converting a DC current provided by the solar energy devices connected to the input 12 into an AC current. The inverter circuits 13 may be configured as single-phase or multi-phase inverter circuits. The inverter circuits 13 have for example half-bridges comprising two switching elements connected in series to each other, the switching elements being power devices, such as for example MOSFETs or IGBTs. Furthermore, each inverter 10x, 10a . . . n comprises an output 14 which is connected via transmission lines 16 to a common bus 18. The total AC current of all inverters 10x, 10a . . . n is supplied from the bus 18 via transmission lines 20 to a grid 22. The grid 22 may be a public grid or an isolated grid.

In addition, each inverter 10x, 10a . . . n comprises a controller 15 formed by e.g. a processor or microcontroller, etc. The inverters 10x, 10a . . . n, more specifically the controllers 15 of the inverters 10x, 10a . . . n, are connected to each other via a communication line 24. The master-inverter 10x controls the switching processes of the inverter circuits 13 of the master-inverter 10x and the slave-inverters 10a . . . n. More precisely, the controller 15 of the master-inverter 10x controls the switching processes of the inverter circuit 13 of the master-inverter 10x as well as, via the respective controllers 15 of the slave-inverters 10a . . . n, the switching processes of the inverter circuits 13 of all slave-inverters 10a . . . n.

In the example of FIG. 1, the inverter system is configured as a master-slave system of inverters. In alternative examples of the present disclosure, there can be a separate master controller to control all inverters of the inverter system, in particular the controllers of all inverters of the inverter system.

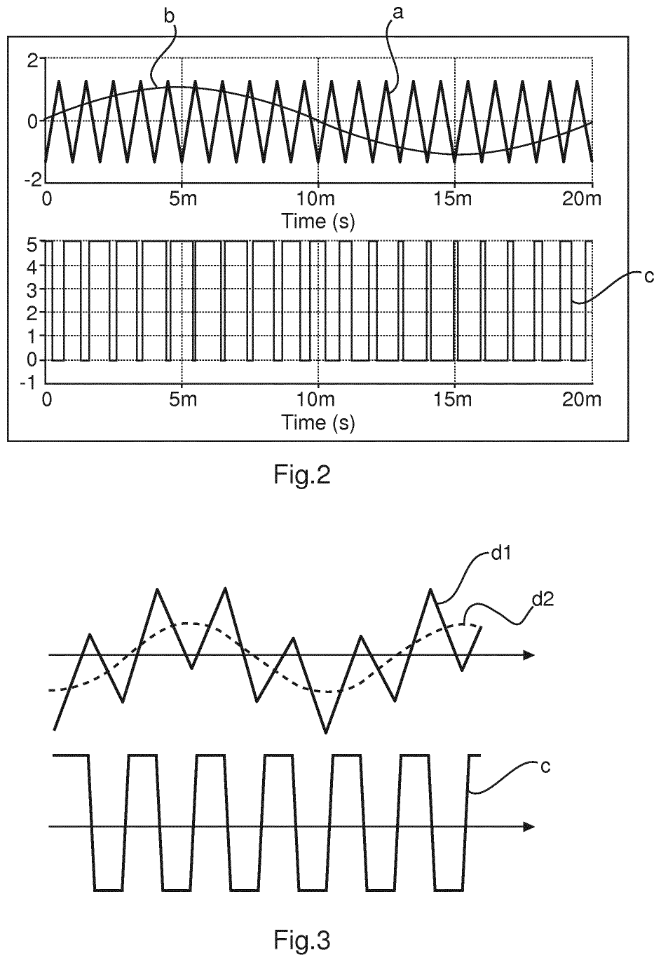

Next, with reference to FIGS. 2 to 6, an example of operating such an inverter system as shown in FIG. 1 according to the present disclosure will be explained.

FIG. 2 shows how the AC output of an inverter 10 is generated by its inverter circuit using pulse width modulation (PWM) switching. The PWM output signal c shown in the lower diagram of FIG. 2 is generated by comparing a carrier wave signal a and a reference wave signal b both shown in the upper diagram of FIG. 2. In the example shown in FIG. 2, the carrier wave signal a has a triangular waveform, but in other examples, the carrier wave signal a may have a saw tooth waveform or some other waveform. The reference wave signal a typically has a sinusoidal waveform. When the reference wave signal b is higher than the carrier wave signal a, the one switching element of a half-bridge of the inverter circuit 13 is triggered on and positive DC voltage is applied to the inverter output 14. In the other case, when the reference wave signal b is lower than the carrier wave signal a, the other switching element of a half-bridge of the inverter circuit 13 is triggered on and negative DC voltage is applied to the inverter output 14. The magnitude and frequency of the reference wave signal b determine the amplitude and the frequency of the output voltage, and the frequency of the carrier wave signal a is called the modulation frequency.

Because of the PWM modulation, there is a switching ripple in the current output of an inverter 10. Especially, the switching ripple in current supplied by an inverter is a result of the square waveform of the PWM output signal c of the inverter. FIG. 3 shows the AC current ripple d1 of an inverter 10 for a small switching frequency, wherein waveform d2 shows the average of the switching ripple.

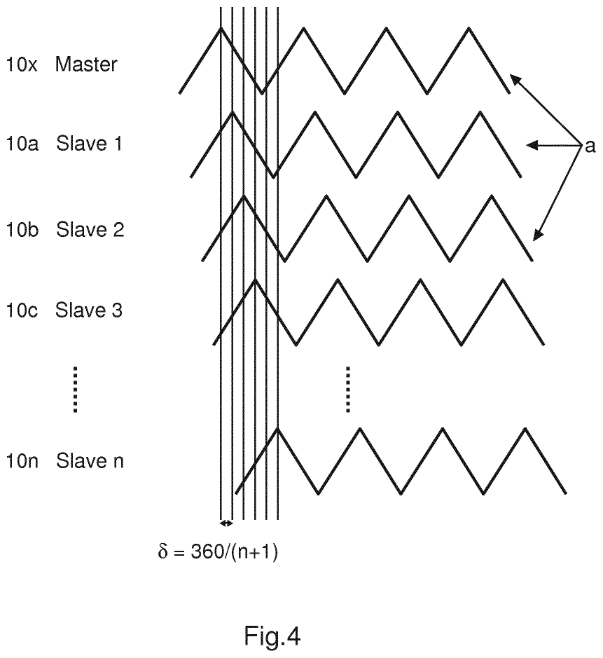

As shown in FIG. 4, the carrier wave signals a of the inverter circuits 13 of all inverters 10 are phase-shifted relative to each other. If some of the inverters 10 are not active, because for example the solar energy devices connected to their inputs 12 are not generating electric current at present, in an example only carrier wave signals a of the inverter circuits 13 of the active inverters 10 are phase-shifted relative to each other. The phase difference δ between the carrier wave signals a of the inverters depends on the total number of inverters 10 or active inverters 10. When m is the total number of (active) inverters 10, the phase difference δ is determined by δ=360°/m.

In the present example of a master-slave system of inverters 10, the master inverter 10x determines the phase shifts of the carrier wave signals a of the inverter circuits 13 of the slave-inverters 10a . . . n. For example, the carrier wave signal a of the master-inverter 10x will be the reference having a phase shift of 0°, whereas the phase shifts of the n slave-inverters 10a . . . n will be equal to ((360°/(n+1)*number of the slave inverter). In detail, the carrier wave signal a of the master-inverter 10x has a phase shift of 0°, the carrier wave signal a of the first slave-inverter 10a has a phase shift of 0°+1δ, the carrier wave signal a of the second slave-inverter 10b has a phase shift of 0°+2δ, and the carrier wave signal a of the n-th slave-inverter 10n has a phase shift of 0°+nδ. In an example of an inverter system comprising four inverters 10, there will be one master-inverter 10x and three slave-inverters 10a, 10b, 10c, resulting in a phase difference δ of 360°/4=90° and phase shifts of 0°, 90°, 180° and 270°, respectively.

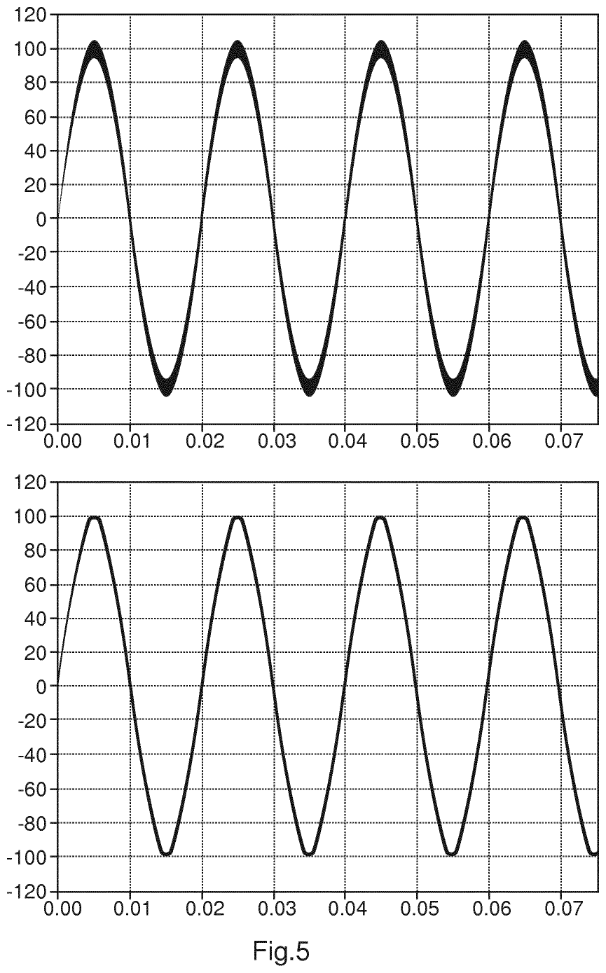

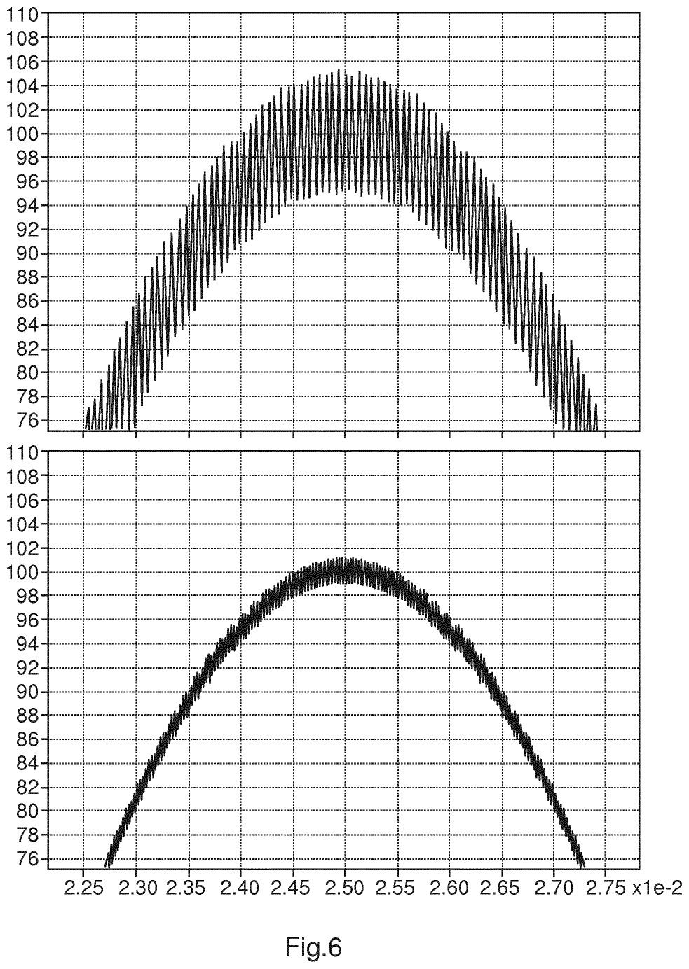

The phase differences between the carrier wave signals a of the inverters 10x, 10a . . . n shift the switching processes of the inverter circuits 13 of these inverters. As a result, also the switching ripples of the current outputs of the inverters 10 are phase-shifted relative to each other. Thus, the summation of the current outputs of all (active) inverters 10 at the bus 18 results in an at least partially mutually elimination of the switching ripples, as it is exemplarily shown in FIGS. 5 and 6.

The upper diagrams of FIGS. 5 and 6 shows the AC current output of an inverter system, i.e. the summation of the AC current outputs of the plurality of inverters 10, according to a conventional solution. The lower diagrams of FIGS. 5 and 6 show the AC current output of an inverter system, i.e. the summation of the AC current outputs of the plurality of inverters 10, according to the present disclosure. As shown in the zoomed details of FIG. 6, the AC current output of the conventional inverter system has a large THD, whereas the switching ripples in the AC current output of the disclosed inverter system are decreased significantly. In an exemplary software simulated inverter system, the magnitude of the switching ripples could be decreased by about 80% for example.

As explained above with reference to FIGS. 1 to 6, the inverter system of the present disclosure does not need bigger or additional circuit elements for filtering the switching ripples at the outputs of the inverters to achieve a better THD and lower switching ripple levels. Instead, there is just added a phase-shifting of the switching processes of the inverters, especially a phase shifting of the carrier wave signals for the switching processes of the inverter circuits of the inverters. Because of its cost effectiveness and simple configuration, the inverter system of the present disclosure is advantageous in particular in solar power systems. The inverter system of the present disclosure can be used in any type of solar farms with a plurality of inverters.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. An inverter system, comprising:
a plurality of inverters each having an input connectable to at least one DC source, an inverter circuit for converting a DC current into an AC current, and an output connected to a bus which is connectable to a grid; and
a controller for controlling said plurality of inverters,
wherein said controller is configured to control the switching processes of said inverter circuits of said plurality of inverters such that the switching processes of at least two inverters of said plurality of inverters are phase-shifted relative to each other.

2. The inverter system of claim 1, wherein one inverter of said plurality of inverters serves as said controller.

3. The inverter system of claim 1, wherein said plurality of said inverters and said controller are connected to each other via a communication line.

4. The inverter system of claim 1, wherein
the switching processes of said plurality of inverters are each controlled by a respective carrier wave signal (a) having a modulation frequency to generate a PWM output signal (c); and
said controller is configured to phase-shift the carrier wave signals (a) of at least two inverters of said plurality of inverters relative to each other.

5. The inverter system of claim 1, wherein a phase difference (δ) between the phase-shifted switching processes of two inverters of said plurality of inverters is δ=360°/m with m being the total number of inverters or active inverters.

6. A solar power system, comprising an inverter system of claim 1 and a plurality of solar energy devices connected to the inputs of said plurality of inverters of said inverter system.

7. A method for operating an inverter system, said inverter system comprising a plurality of inverters each having an input connectable to at least one DC source, an inverter circuit for converting a DC current into an AC current, and an output connected to a bus which is connectable to a grid,
wherein the switching processes of said inverter circuits of said plurality of inverters are controlled such that the switching processes of at least two inverters of said plurality of inverters are phase-shifted relative to each other.

8. The method of claim 7, wherein the switching processes of said inverter circuits of said plurality of inverters are controlled by one inverter of said plurality of inverters which acts as a master-inverter.

9. The method of claim 7, wherein the switching processes of said plurality of inverters are each controlled by a carrier wave signal (a) having a modulation frequency to generate a PWM output signal (c), said carrier wave signals (a) of at least two inverters of said plurality of inverters being phase-shifted relative to each other.

10. The method of claim 7, wherein a phase difference (δ) between the phase-shifted switching processes of two inverters of said plurality of inverters is δ=360°/m with m being the total number of inverters or active inverters.
